(19) United States
(12) Patent Application Publication
(10) Pub. No.: US 2008/0215207 A1
(43) Pub. Date: Sep. 4, 2008

(54) Device For Testing Systems, Functions or Components of a Motor Vehicle Independently of a Test-Bench

(76) Inventor: Thomas Heinze, Duisburg (DE)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/816,752

(22) PCT Filed: Feb. 26, 2006
(86) PCT No.: PCT/DE06/00352

§ 371 Date: Aug. 21, 2007

(30) Foreign Application Priority Data
Feb. 27, 2005 (DE) 20 2005 003 284.0

(51) Int. Cl. G01M 13/02; G01M 17/007

(52) U.S. Cl. 701/33; 701/29; 701/35

(57) ABSTRACT

The invention relates to a motor vehicle that is provided with a device for testing the systems, functions or components of the vehicle. According to the invention, the vehicle is jacked-up and is equipped with an actuator or a driver to operate the brakes of the vehicle. The vehicle propulsion can rotate freely against the load of at least one brake of the vehicle and the freely rotating wheel or wheels have no frictional connection to the tread contact area of the vehicle. The brakes and/or the propulsion load can be controlled by actuators having a controller or by the driver in accordance with specific signals of the operating condition of the drive train of the vehicle.

### CROSS-REFERENCE TO RELATED APPLICATIONS

This application is an U.S. national phase application under 35 U.S.C. §371 based upon co-pending International Application No. PCT/DE2006/000352 filed on Feb. 26, 2006. Additionally, this U.S. national phase application claims the benefit of priority of co-pending International Application No. PCT/DE2006/000352 filed on Feb. 26, 2006 and German Application No. 202005003284.0 filed on Feb. 27, 2005. The entire disclosures of the prior applications are incorporated herein by reference. The international application was published on Aug. 31, 2006 under Publication No. WO 2006/089536 A1.

### BACKGROUND OF THE INVENTION

1. Field of the Invention

The invention relates to a device for testing systems, functions or components of a motor vehicle according to the genus of the main claim.

2. Description of the Prior Art

Systems, functions or components, as required for operating a motor vehicle, are tested on appropriate test benches or in appropriate drive cycles with driving tests on the road. This type of tests requires complex test benches, such as e.g. engine and/or roller-type test benches, or trained drivers for driving the vehicles on the road. It would thus be very advantageous if the cost and time expenditures for test benches or personnel could be reduced and if, as a result, the corresponding costs and, where applicable, certain driver-specific influences on the test result could be reduced.

### SUMMARY OF THE INVENTION

In contrast to the above, the device according to the invention with the features of the main claim has the advantage that test bench expenditures and deployment of personnel with regard to time and cost expenditures are saved. Complex test bench structures may, in part, be dispensed with entirely. The basic concept of the invention is to utilize—to the extent possible—the components, functions and/or systems already integrated into the motor vehicle, in order to test, if possible automatically, other, new components, functions and/or systems integrated into the motor vehicle.

In a particularly advantageous embodiment of the invention, test sequences in the described device are to be controlled by the OBD-interface integrated into the vehicle, the brakes existing in the vehicle being used for stressing the drive train.

The brakes integrated into the vehicle can, as a rule, substantially decrease the engine output. As a result, for testing purposes, they are also extremely well suited for stressing the drive train. According to the invention, the braking power required for test purposes in a motor vehicle featuring the simultaneous control of the accelerator and brake units is to be provided via the vehicle brakes, the vehicle wheels being allowed to run freely by jacking up the vehicle and, if required, the waste heat from the brakes being withdrawn by cooling means, e.g. by appropriately blowing against them using cooling fans. Controlling the brakes to attain the required braking power may, for example, be performed by automatically actuating the brake pedal by means of an actuator or by a driver actuating the brake pedal.

In order to control the testing procedure either additional sensors at appropriate locations or already existing sensor signals of sensors previously installed in the motor vehicle may be used. Signals from standardized interfaces, such as e.g. the OBD-interface or CAN-bus are particularly suited here. Signal processing is performed by a suitable control device, e.g. via a measured data recording system including a control unit. The control device is in this context used to so operate the internal combustion engine (BKM) and the brakes of a motor vehicle with the aid of the recorded sensor data, under appropriate operating conditions, e.g. by specifying a specific driving profile, that the components, functions and/or systems to be tested are stressed in accordance with specifications.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic diagram of the preferred embodiment of the device for testing systems, functions or components of a motor vehicle independently of a test bench constructed in accordance with the principles of the present invention, with any phantom lines depicting environmental structure and forming no part of the claimed invention.

### DESCRIPTION OF THE PREFERRED EMBODIMENT

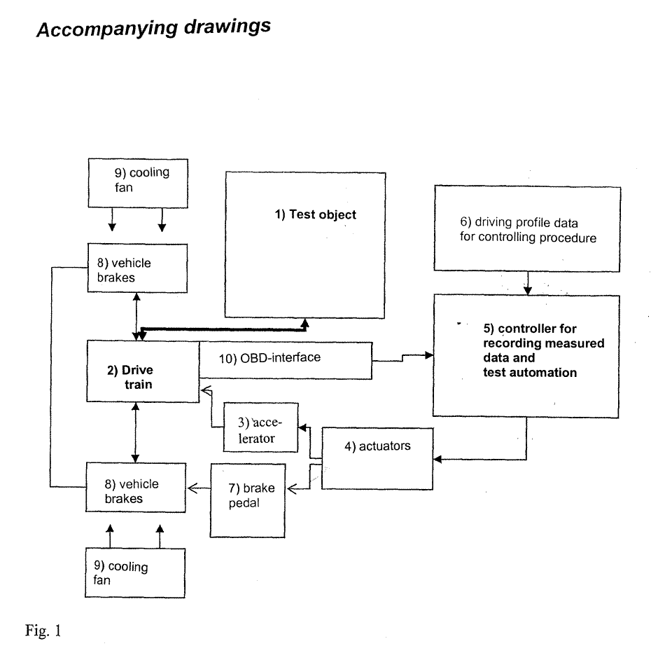

FIG. 1 shows a schematic representation of a preferred embodiment. The test object 1 is in an interactive relationship with the drive train of the vehicle, thereby experiencing the stressing required for testing the test object. The drive train is operated via the logical chain of the driving profile data 6, controller for recording measured data/test automation 5, actuators 4 and accelerator 3. Stressing of the drive train is performed by the logical chain of the driving profile data 6, controller for recording measured data/test automation 5, actuators 4, brake pedal and vehicle brakes 8. The vehicle brakes are protected against overheating by suitable cooling fans 9. The controller for recording measured data/test automation 5 receives operating parameters of the drive train from the OBD-interface 10, e.g. rotational speed and load of an internal combustion engine so that these may be adjusted according to the driving profile data.

1-22. (canceled)

23: A motor vehicle testing system for testing the systems, functions or components of a motor vehicle independently of a test-bench, said motor vehicle testing system comprising:
a jack-up device for jacking-up a vehicle required for testing on at least one drive wheel, so that the latter exhibits no frictional connection to a tread contact area of the vehicle; and
a means for operating a brake system equipped in the vehicle;
wherein a drive unit of the vehicle being able to rotate freely against a load applied by the brakes of the vehicle;
wherein the vehicle having freely rotating wheels with no frictional connection to the tread contact area of the vehicle.

24: The motor vehicle testing system according to claim 23 further comprising a cooling means for protecting the vehicle brakes against overheating by applying a coolant by means of a fluid distributor and/or by setting into motion a cooling gas flow by blowing against it.

25: The motor vehicle testing system according to claim 24 further comprising a regulating means which controls the cold air flow and/or the amount of coolant as a function of brake temperature.

26: The motor vehicle testing system according to claim 23, wherein the vehicle is provided with a control means so that an engine of the vehicle and the brakes of the vehicle may be controlled by actuators having an electronic controller for recording measured data and/or test automation and controlling the vehicle by specific control data sets in a driving profile.

27: The motor vehicle testing system according to claim 26, wherein the controller uses control data sets which have been generated by vehicle rides.

28: The motor vehicle testing system according to claim 27, wherein the control data sets describe emission cycles.

29: The motor vehicle testing system according to claim 27, wherein the control data sets are used which have been generated by prolonged run cycles.

30: The motor vehicle testing system according to claim 23 further comprising a controller for recording measured data and/or test automation receiving signals on the operational status of the drive train of the vehicle.

31: The motor vehicle testing system according to claim 30, wherein the signals are emitted by an OBD-interface.

32: The motor vehicle testing system according to claim 30, wherein the signals are emitted by a vehicle-integrated data bus.

33: The motor vehicle testing system according to claim 23, wherein the rotational speed of a vehicle engine and the vehicle engine load is used for controlling the drive train and the vehicle brakes.

34: The motor vehicle testing system according to claim 34, wherein a sensor is used for controlling the drive train and the vehicle brakes, the sensor being selected from the group consisting of a rotational speed sensor, a pedal value sensor, an air mass sensor, and an injection quantity sensor.

35: The motor vehicle testing system according to claim 23, wherein the motor vehicle testing system is suitable for testing an exhaust gas system.

36: The motor vehicle testing system according to claim 23 further comprising a temperature control unit adapted to control the temperature of the vehicle components to be tested.

37: A motor vehicle testing system for testing the systems comprising:
a jack-up device for jacking-up a vehicle required for testing on at least one drive wheel, so that the latter exhibits no frictional connection to a tread contact area of the vehicle;
a cooling system for protecting the brakes against overheating;
a regulating means for controlling the cooling system as a function of brake temperature; and
a control means for controlling the brakes and drive unit of the vehicle by actuators having an electronic controller for recording measured data and controlling the vehicle by specific control data sets in a driving profile;
wherein a drive unit of the vehicle being able to rotate freely against a load applied by the brakes of the vehicle;
wherein the vehicle having freely rotating wheels with no frictional connection to the tread contact area of the vehicle.

38: The motor vehicle testing system according to claim 37, wherein the signals are emitted by an OBD-interface.

39: The motor vehicle testing system according to claim 37, wherein the signals are emitted by a vehicle-integrated data bus.

40: The motor vehicle testing system according to claim 37, wherein the rotational speed of a vehicle engine and the vehicle engine load is used for controlling the drive train and the vehicle brakes.

41: The motor vehicle testing system according to claim 37, wherein a sensor is used for controlling the drive train and the vehicle brakes, the sensor being selected from the group consisting of a rotational speed sensor, a pedal value sensor, an air mass sensor, and an injection quantity sensor.

42: A method for testing the systems, functions or components of a motor vehicle independently of a test-bench, said method comprising the steps of:
(a) providing a motor vehicle testing system comprising: a jack-up device for jacking-up a vehicle required for testing on at least one drive wheel, so that the latter exhibits no frictional connection to a tread contact area of the vehicle; a cooling system for protecting the brakes against overheating; a regulating means for controlling the cooling system as a function of brake temperature; and a control device for controlling the brakes and drive unit of the vehicle by actuators having an electronic controller for recording measured data and controlling the vehicle by specific control data sets in a driving profile;
(b) obtaining and storing control data sets in a driving profile from actual vehicle rides;
(c) lifting the motor vehicle using the jack-up device so that at least one drive wheel exhibits no frictional connection to the tread contact area of the wheel;
(d) attaching one of the actuators to a brake pedal and another actuator to an accelerator pedal;
(e) connecting the electronic controller to an OBD-interface of the vehicle;
(f) initiation a test procedure using the driving profile for controlling procedure;
(g) controlling the vehicle drive unit by the control unit;
(h) controlling the brakes by the control unit so as to apply a load against the drive unit;
(i) cooling the brakes using the cooling system;
(j) controlling the cooling the fan as a function of brake temperature using the regulating means;
(k) controlling the drive train and the vehicle brakes by the rotational speed of a vehicle engine and the vehicle engine load; and
(l) recording measured data using the electronic controller.
